(19) United States
(12) Patent Application Publication
(10) Pub. No.: US 2007/0196626 A1
(43) Pub. Date: Aug. 23, 2007

(54) Multi-component molded plastic part

(76) Inventor: Franz Josef Summerer, Rimsting (DE)

Correspondence Address: STAAS & HALSEY LLP, SUITE 700, 1201 NEW YORK AVENUE, N.W., WASHINGTON, DC, 20005, US

(21) Appl. No.: 11/702,674

(22) Filed: Feb. 6, 2007

(30) Foreign Application Priority Data
Feb. 6, 2006 (DE) 10 2006 005 303.6

(51) Int. Cl. B32B 23/02

(52) U.S. Cl. 428/192

(57) ABSTRACT

A molded plastic part comprises a plastic part and a plastic component molded onto the plastic part. The plastic part has a portion at the border which is insert-molded by the polymer melt of the molded-on plastic component.

### BACKGROUND OF THE INVENTION

The invention relates to a molded plastic part which comprises a plastic part with a molded-on plastic component.

For the production of single-component molded plastic parts, the injection-molding and compression processes known in plastics processing are used. Conventional injection-molding processes without a compression technique are used in particular for the production of relatively small injection-molded parts, in the case of which short flow paths occur and it is possible to work with moderate injection pressures. In the case of the conventional injection-molding process, the polymer melt is injected into a cavity formed between two closed, positionally fixed mold plates and solidifies there.

Compression processes differ from conventional injection-molding processes in that the injecting and/or solidifying operation is carried out while performing a mold plate movement. The polymer melt is compressed while performing a mold movement in the closing direction. In particular in the production of large-area and thin-walled molded parts, the (more complex) compression technique is suitable, since in this way a lowering of the high injection pressures required in the case of large molded parts can be achieved. Furthermore, stresses or warpage in the injection-molded part, which occur as a result of high injection pressures, can be avoided by the compression technique.

Multi-component molded plastic parts may be produced by molding the second component onto the prefabricated first component of the molded plastic part. For this, a molding-on mold plate is placed against the already prefabricated first component of the molded plastic part, creating a cavity for the formation of the second component between the first component of the molded plastic part and the molding-on mold plate.

When molding the second component onto the first component, the difficulty may arise that the cavity for the second component has to be adequately sealed with respect to the already produced first component. Leakages may occur at the vertical flash face clearance. If the second component does not continuously cover the first component, leakages may also occur at the transitions between the second component and the first component.

A further problem in the production of multi-component molded plastic parts may be that, if it is an injection-molded plastic part, the first component has a fin (for example the fin of the vertical flash face clearance) at its border. This fin may be troublesome during following processing steps and is often subsequently removed to make a smooth border of the molded plastic part possible.

### BRIEF DESCRIPTION OF THE DRAWINGS

The invention is explained in more detail below by way of example on the basis of exemplary embodiments with reference to the drawings, in which:

FIG. 1 shows in a sectional representation two closed mold plate halves, between which the first component of a two-component injection-molded part is produced in the form of a glazing unit of a motor vehicle;

FIG. 2 shows in a sectional representation two closed mold plate halves, between which a second component (black border) is molded onto the first component represented in FIG. 1;

FIG. 3 shows a detail A1 from FIG. 1;

FIG. 4 shows a detail A2 from FIG. 2, but before the closing of the two mold plates;

FIG. 4a shows a representation corresponding to FIG. 4, the first component exclusively comprising a film;

FIG. 5 shows the detail A2 that is shown in FIG. 2, with closed mold plates;

FIG. 5a shows a representation corresponding to FIG. 5, the first component exclusively comprising a film;

FIGS. 6-21 show partial sectional representations of the molds for producing the first component with an insert-molded film and for molding the second component onto the first component in the process sequence;

FIG. 22 shows a vertical flash face slide, realized as an oblique slide, with the mold open; and

FIG. 23 shows a vertical flash face slide, realized as an oblique slide, with the mold closed.

### DETAILED DESCRIPTION OF THE INVENTION

Embodiments comprise a method of molding a plastic component onto a plastic part which is located on a first mold plate and in which a sealing element projecting beyond the surface of the first mold plate is formed at the border. A second mold plate is brought up close to the first mold plate, a sealing face being provided on the second mold plate in the region of the sealing element. To mold the plastic component onto the plastic part, plastic is injected into a cavity between the plastic part and the second mold plate that is sealed at the border by contact between the sealing element and the sealing face.

While in the case of conventional molding-on methods, the sealing of the cavity for the plastic component is controlled at the border by means of a sealing gap, often the vertical flash face clearance, the embodiment makes an additional or alternative way of sealing the cavity possible by the provision of the sealing element on the plastic part and the interaction of this sealing element with a sealing face on the second mold plate. The interaction of the sealing element of the plastic part with the second mold plate has the advantage of great freedom from wear on the mold and a much greater variability of the way in which the process is conducted. The latter is obtained by the sealing only being dependent to a much lesser extent on the plate position or a plate movement of the second mold plate in relation to the first mold plate. In particular, it is therefore possible to carry out the molding-on of the plastic component (i.e. of the second component) when performing a mold movement, i.e. by a compression method. In this way, large-area, thin-walled, high-quality, multi-component molded plastic parts can be produced.

In addition, it is made possible to create a molded plastic part with a rounded and step-free border. This is so since, as long as the plastic part (first component) is an injection-molded plastic part, its fin, in particular the fin of the vertical flash face clearance, can be located within the sealing element deliberately formed there and is insert-molded and incorporated in the overall form by injecting the plastic for the plastic component.

The sealing element may be flexurally elastic. The flexural elasticity of the sealing element allows a seal that is tolerant to movement to be created.

At the beginning of the injection operation, the sealing element may already lie in contact with the sealing face of the second mold plate under flexural prestress, or it is also possible for the contact only to be brought about by the injection of the plastic and a resultant bending of the sealing element.

The mold plates may be spaced apart already at the beginning of the injection of polymer melt of the plastic component to be molded on, i.e. a compression process with a pre-enlarged molding-on cavity can be carried out for the molding-on of the plastic component. In this way, multi-component molded plastic parts with particularly low warpage can be produced.

According to one embodiment, the mold plates may be moved apart during the injection of polymer melt into the cavity. During the moving apart of the mold plates, the sealing element may remain in sealing contact with the sealing face on the second mold plate; should this not be the case entirely, at least an additional sealing effect is retained. The moving apart of the mold plates allows the plastic that is used to compensate for shrinkage to be added.

If the cavity has been pre-enlarged before and/or during the filling, the mold plates can be moved together again for the shrinkage compensation (compression step). During the moving together of the mold plates, the sealing element arranged on the plastic part comes into sealing contact or remains in sealing contact with the sealing face on the second mold plate.

Various possible ways of realizing the seating element on the plastic part are available. According to a first way, the plastic part may be an injection-molded plastic part containing a film. In this case, the sealing element may be realized as a film projection on the injection-molded plastic part. This configurational variant is particularly simple because a film projection can be realized by a simple cutting process, which is expediently carried out outside the mold, without special measures for realizing the sealing element having to be performed on the mold for producing the first component (i.e. the plastic part). However, it is also possible for a sealing element that is molded integrally onto the injection-molded plastic part to be used. This may be formed without an inserted film, or an end portion of the film may protrude into the sealing element at least over a partial portion.

The plastic part may also be an injection-molded plastic part without an inserted film. In this case, the sealing element is for example a sealing element that is molded integrally onto the injection-molded plastic part.

Another advantageous possibility is that the plastic part is exclusively a film. In this case, only a single injection-molding step (namely for molding the second component onto the film) need be carried out to produce the molded plastic part. The sealing element is in this case the end of the film.

One embodiment of the molded plastic part comprises a plastic part and a plastic component molded onto the plastic part, the plastic part having a portion or projection at the border that is insert-molded by the polymer melt of the molded-on plastic component. For example, the portion may be bent back onto the plastic part. In many cases, the portion projecting from the plastic part does not represent any significant restriction for practical purposes and can be readily accepted in view of the advantages that can be achieved with the invention (for example the possibility of producing the molded-on plastic component by a compression process, possibly also the elimination of fin removal and the realization of a visually satisfactory border).

Multi-component molded plastic parts are required in many fields of use. For example, transparent glazing units (for example window panes) of motor vehicles are produced with a second plastic component running around the glazing unit in the manner of a frame—known as a black border. The surrounding black border is injection-molded onto a border portion of the first component and creates a window on the first component, it not being possible for the inner sealing transition between the black border and the window to be sealed by a vertical flash face.

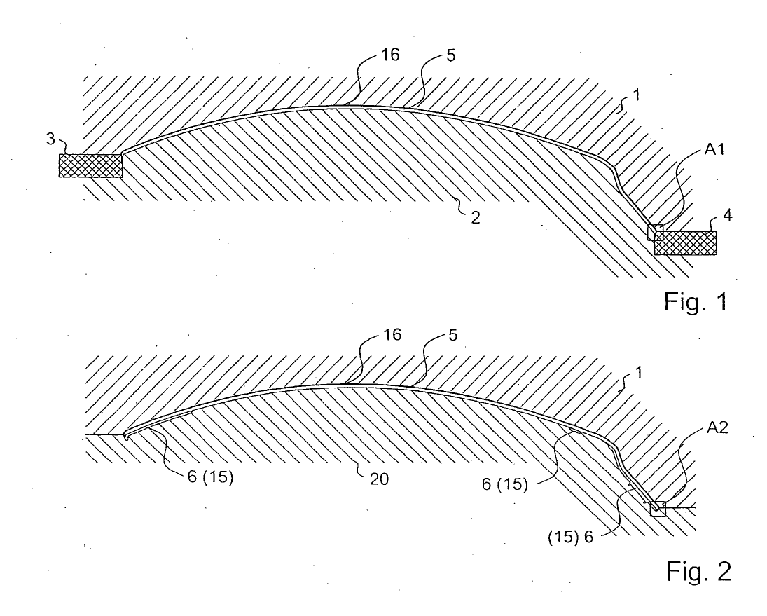

FIG. 1 shows in a partial sectional representation a mold plate 1, a counter mold plate 2 and a cavity which is formed between the two mold plates 1, 2 and in which the first component 5 of a multi-component molded plastic part according to the invention is produced. Also represented are vertical flash face slides 3 and 4, which are described in more detail below and form the vertical flash face clearance in the border region of the cavity.

The two mold plates 1, 2 are located in a way not represented between the platens of an injection-molding machine and can be moved apart and—as shown in FIG. 1—moved together and closed by means of the injection-molding machine. The mold plate 1 is formed for example as what is known as the female mold plate with a trough-shaped depression, while the counter mold plate 2 forms for example what is known as the core mold plate with a mold core protruding into the trough-shaped depression. Not represented in FIG. 1 is a hot runner, via which plastic for the first component 5 can be introduced into the cavity between the two mold plates 1, 2.

The first component 5 is, for example, a transparent glazing unit for a motor vehicle. The production of motor vehicle glazing units by injection-molding processes is technologically difficult, since, on account of the long flow paths, high injection pressures have to be applied and on the other hand high requirements have to be met with respect to the optical quality and freedom from warpage of the glazing unit.

In the case of the example represented here, the first component 5 comprises a transparent film 16 on the female plate side, which in the course of the production of the first component 5 is insert-molded with the plastic material of the first component 5, as explained in more detail below.

FIG. 2 shows a partial sectional view of the mold that is used for molding the second component 6 onto the first component 5. This mold also uses the mold plate 1. However, the counter mold plate 2 is exchanged for a molding-on mold plate 20. The molding-on mold plate 20 is likewise a core mold plate and in the example represented here has over extensive portions a sectional mold-core contour line similar to that of the counter mold plate 2. However, one of the ways in which the molding-on mold plate 20 differs from the counter mold plate 2 is that, when the mold plates are closed (as shown in FIG. 2), cavities 15 are formed between the first component 5 and the core surface of the molding-on mold plate 20. The plastic material for the second component 6 is injected into these cavities 15, i.e. the cavities define the form of the second component 6 that is molded onto the first component 5. In the present example, it is intended for example to mold onto the first component 5 what is known as a black border 6, which covers the first component 5 at the border in the manner of a frame, which is for example non-transparent. Hot runners for supplying the plastic for the molding-on of the second component 6 are not represented in FIG. 2.

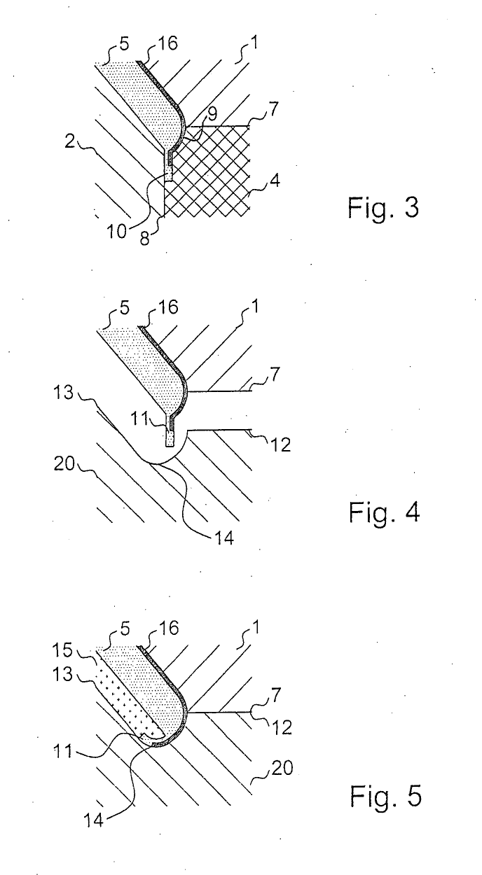

FIGS. 3 to 5 show partial sectional representations of the border region of the mold cavities represented in FIGS. 1 and 2.

FIG. 3 shows the border of the first component 5 in the closed mold 1, 2, 4 according to detail A1. On the surface of the first component 5 on the female plate side there is, as already mentioned, a transparent, preferably preformed (thermoformed) and ready-trimmed film 16. The transparent film 16 projects beyond the surface 7 of the mold plate 1 that is adjacent the cavity, i.e. protrudes out of the depression that is characteristic of the female mold plate 1. The depression has a curved side wall profile.

The vertical flash face slide 4, which is displaceable along the surface 7, interacts in its closed position both with the surface 7 of the mold plate 1 and with a lateral sealing face 8 of the counter mold plate 2. In the region of the projection between the female depression in the mold plate 1 and the surface 7, it has a border contour portion 9, which continues the curvature of the female depression in the mold plate 1 and, as it continues, goes over into a recess 10 at a distance from the sealing face 8. The recess 10 of the vertical flash face slide 4 and the sealing face 8 of the counter mold plate 2 define a receiving volume which is in connection with the cavity that is present between the mold plate 1 and the counter mold plate 2 and represents a deliberately extended upper portion of the vertical flash face clearance. The film 16 projects over a certain length into this receiving volume. In other words, the vertical flash face slide 4 creates a vertical flash face clearance with a stepped vertical flash face clearance dimension.

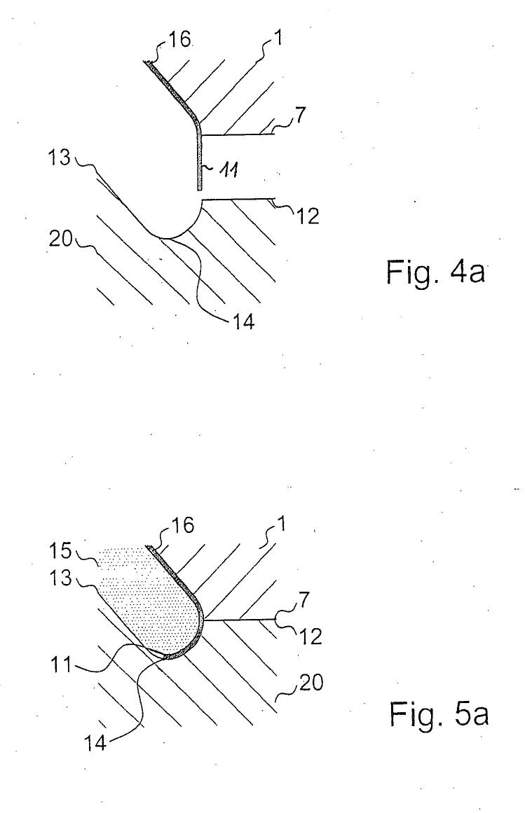

FIG. 4 shows the border region of the insert-molded first component 5 that is formed according to FIG. 3. Complementing the shaping of the vertical flash face slide 4 (round contour portion 9 and recess 10), a sealing continuation 11 is arranged at the outer end of the first component 5 in the manner of a fin of the vertical flash face clearance that is deliberately increased in its thickness and into which the outer film 16 protrudes in the way described.

The molding-on mold plate 20 has at the transition between its outer surface 12, on the outside with respect to the cavity, and the mold core 13 a trench-like depression portion 14. The shaping of the depression portion 14 corresponds in the upper region to the shaping of the border contour portion 9 of the vertical flash face slide 4. At that point at which the curved border contour face 9 on the vertical flash face slide 4 goes over into the recess 10, the curved profile of the depression portion 14 continues on the molding-on mold plate 20. The further shaping of the profile of the depression portion 14 is also based on the desired contour of the second component.

When the mold plate 1 is brought up close to the molding-on mold plate 20, the flexurally flexible sealing continuation 11 comes into contact with the depression portion 14 in the molding-on mold plate 20 and is inwardly deflected by the latter. FIG. 5 shows a sectional representation according to detail A2 in FIG. 2 with mold plates 1, 20 closed. The flexible sealing continuation 11 lies against the bottom of the depression portion 14 over a large part of its length and can be bent back over the first component 5. The end of the film, which does not have to reach up to the end of the sealing continuation 11, may also be bent back over the first component 5. The sealing continuation 11 and the round contour adjoining it of the first component 5 up to the surface 12 of the molding-on mold plate 20 interact with the depression portion 14 in the molding-on mold plate and laterally seal the cavity 15 located between the molding-on mold plate 20 and the first component 5 for the molding of the second component (for example black border) onto the first component 5.

It is pointed out that the seal can be tolerant to play and movement on account of the dimensional elasticity and flexibility of the sealing continuation 11. As a result, a good sealing effect is achieved even when the two mold plates 1, 20 are somewhat spaced apart, since the flexible sealing continuation 11 still lies against the bottom of the depression portion 14 over part of its length. For the same reason, dimensional inaccuracies, tolerances or movement play between the mold plates 1, 20 also only lead to leakages when they become relatively great.

A seal that is tolerant to movement can also be achieved in a way not represented by the sealing face 14 being formed substantially parallel to the direction of plate movement (i.e. perpendicular to the surface 12 of the molding-on mold plate 20) and interacting in the manner of a sliding seal with a side face of the sealing continuation 11 that is likewise oriented parallel to the direction of plate movement. In this case, too, a certain flexural flexibility of the sealing continuation 11 is advantageous for producing prestress. In the case of this solution there will typically be lower run-in tolerances, without a run-in bevel or rounding of the sealing face 14.

The sealed cavity 15 is then filled with the plastic for the second component 6. The filling may be carried out, as represented in FIG. 5, with the mold plates. 1, 20 completely closed. It is equally possible to create a pre-enlarged (but largely sealed) cavity 15 by slight spacing apart of the mold plates 1, 20, subsequently inject polymer melt and, in a final compression step, compress the polymer melt to compensate for shrinkage. The enlargement of the cavity 15 may also only be performed during the filling operation. By molding the second component 6 onto the first component 5, the sealing continuation 11 is insert-molded and embedded into the contour of the second component 6. As can be seen from FIG. 5, the sealing continuation 11 protrudes beyond a plane that is defined by the interface between the first component 5 and the second component 6. It may in this case form a border region of the two-component molded plastic part 5, 6 at the level of the second component 6, i.e. extend at the side of the second component 6 and laterally border it.

It is pointed out that, in the case of the exemplary embodiment represented in FIGS. 1 to 5, there is no vertical flash face clearance between the mold plates 1 and 20. The sealing solution that is achieved according to the invention by product design therefore takes the place of a seal obtained by means of a vertical flash face clearance or some other sealing gap.

FIGS. 4a and 5a differ from FIGS. 4 and 5 essentially only in that a film 16 (without an injection-molded plastic part) is exclusively used as the first component 5. In this case, the step of injection-molding the sealing continuation 11 that is represented in FIG. 3 is omitted.

The bending round of the sealing continuation 11 or the film 16 in FIGS. 5 and 5a may possibly lead to damage (cracks, ruptures), in particular in the case of relatively thick films. To prevent this, it may be envisaged to heat the sealing continuation 11 or the film 16 before or during the bending process. This may be accomplished for example by supplying heat (for example by thermal radiation) in the situation represented in FIGS. 4, 4a. Another possibility is for the mold plate 20 to be specifically heated in the region of the depression portion 14, so that a heat transfer takes place when the sealing face is contacted.

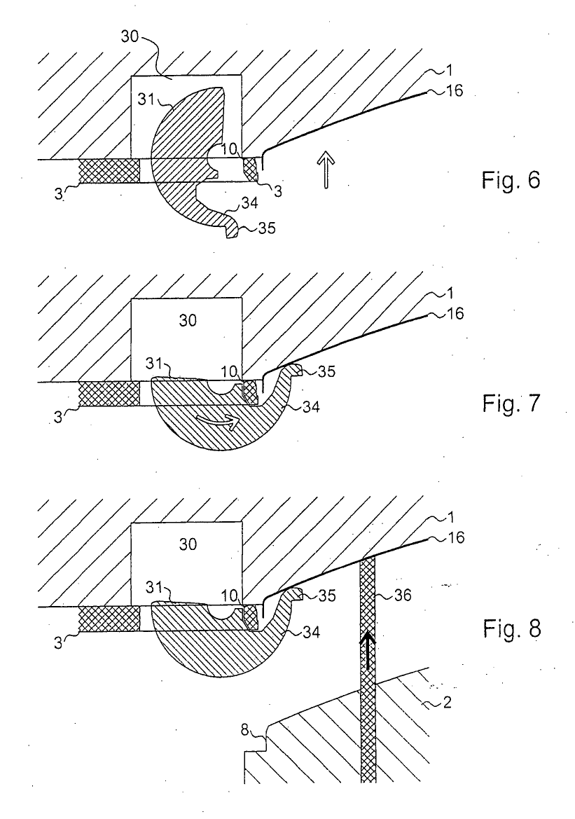

FIGS. 6 to 21 show by way of example the individual method and handling steps in the production of a two-component molded plastic part in greater detail. The same designations are used to identify the same, similar or functionally equivalent parts. FIG. 6 shows the mold plate 1, in the depression of which the film 16 is laid (see arrow). The first mold plate 1 is equipped with the vertical flash face slide 3 (which corresponds mirror-invertedly to the vertical flash face slide 4) and a holding mechanism 30. The holding mechanism 30 has a semicircular disk 31. The semicircular disk 31 is rotatably mounted in the central region about a shaft (not represented) and can be rotated about the shaft by means of an actuating device (not represented). At the lower end of the semicircular disk 31, a holding catch 34 with a pressing region 35 is provided.

The vertical flash face slide 3 is initially in the retracted position. The holding catch 34 is pivoted by the actuating device into the trough-shaped depression of the mold plate 1 and, with its pressing region 35, fixes the film 16 (FIG. 7).

According to FIG. 8, the mold core of the counter mold plate 2 is provided with a bore, through which a holding pin 36 can be pushed out. The pushed-out holding pin 36 additionally fixes the film 16.

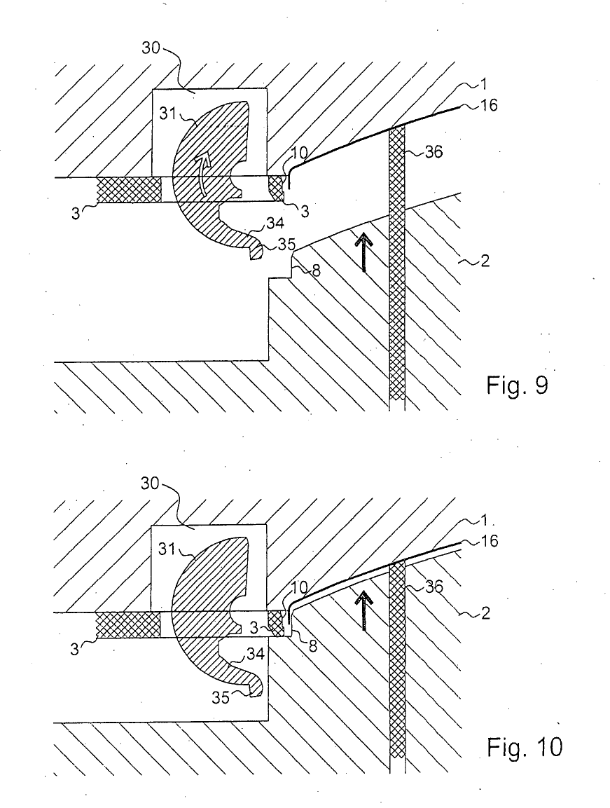

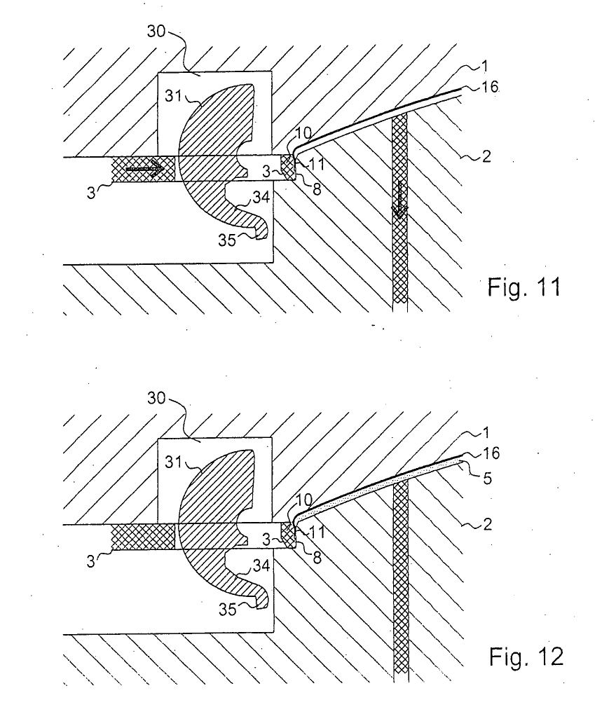

Subsequently, the semicircular disk 31 is turned back, whereby the holding catch 34 is pivoted out from the intermediate space between the female depression of the mold plate 1 and the mold core of the counter mold plate 2 (FIG. 9). The two mold plates 1, 2 are then closed (FIG. 10). Subsequently, the vertical flash face slide 3 is pushed in the direction of the arrow toward the sealing face 8 of the mold core, i.e. brought into its closing position. As this happens, a film projection 11, which corresponds to the sealing continuation 11 shown in FIG. 3, enters between the sealing face 8 of the mold core of the counter mold plate 2 and the recess 10 on the vertical flash face slide 3. As a difference from the representation in FIG. 3, here the recess 10 is dimensioned in such a way that a sealing effect is created here with respect to the film 16, i.e. the film 16 lies against the corresponding faces on both sides. Here, the sealing continuation 11 is realized exclusively by the film 16. Different film thicknesses and types of film can be used without modification of the mold. In a next step, plastic is introduced into the cavity between the mold plate 1 and the counter mold plate 2 and the first component 5 is produced, see FIGS. 11 and 12. Before or during the introduction, the holding pin 36 is retracted. An injection-compression process is preferably used as the production method.

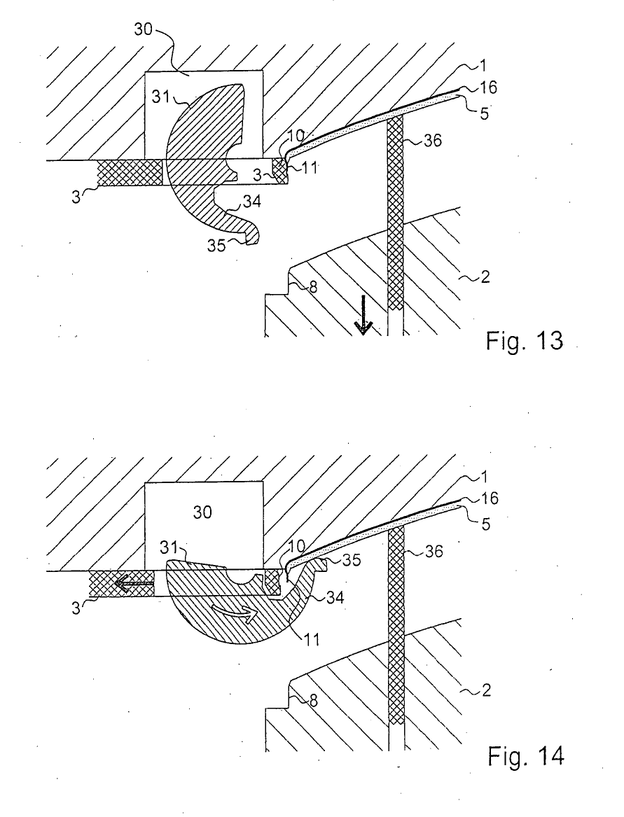

FIG. 13 shows the opening of the two mold plates 1 and 2, the holding pin 36 then being used for fixing the first component 5 produced (insert-molded film 16).

According to FIG. 14, the holding mechanism 30 is then actuated, the holding catch 34 pivoting in and the pressing region 35 supporting the prefabricated first component 5. The vertical flash face slide 3 is retracted, see FIG. 14.

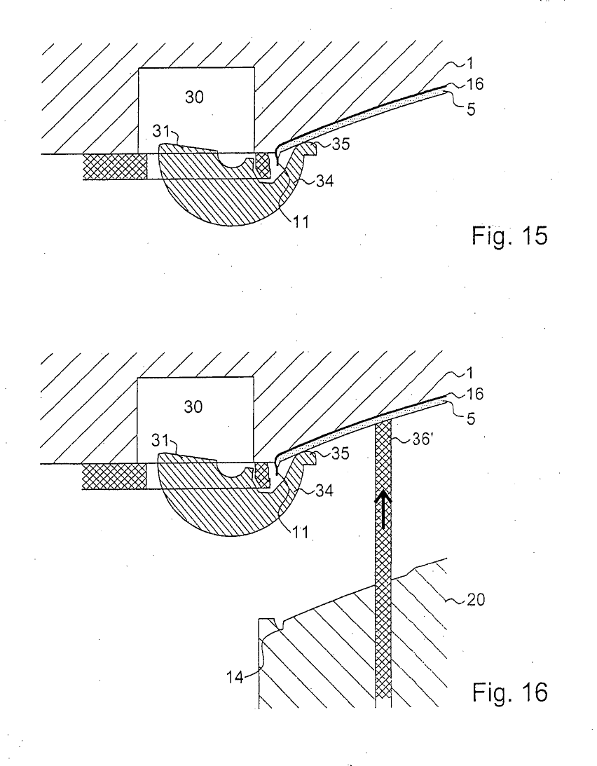

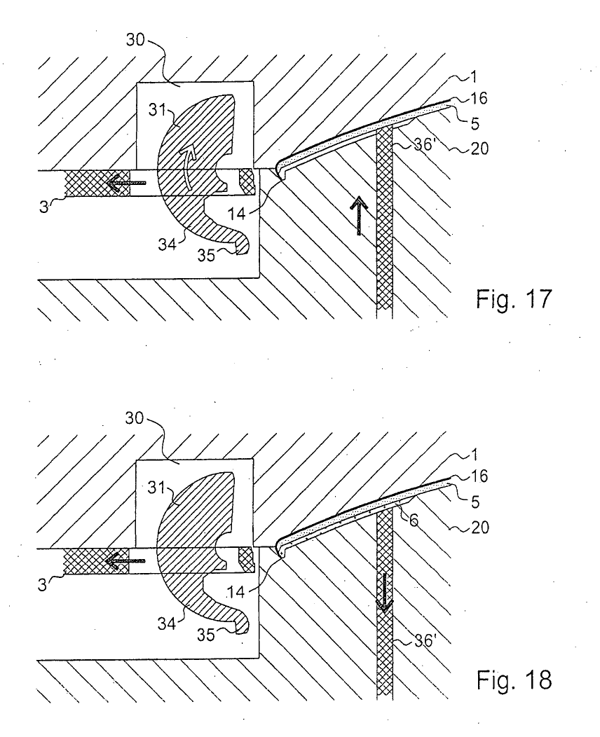

The counter mold plate 2 is then removed and exchanged for the molding-on mold plate 20, see FIGS. 15 and 16. The molding-on mold plate 20 likewise has a holding pin 36′, which in the extended state holds the prefabricated first component 5 in the depression of the mold plate 1. Following this, the holding catch 34 is pivoted back and the mold plate 1 and the molding-on mold plate 20 are moved together and closed or virtually closed, see FIG. 17. The holding pin 36′ is retracted (FIG. 18) and polymer melt for the second component 6 is introduced into the cavity 15 between the first component 5 and the molding-on mold plate 20, see FIG. 18.

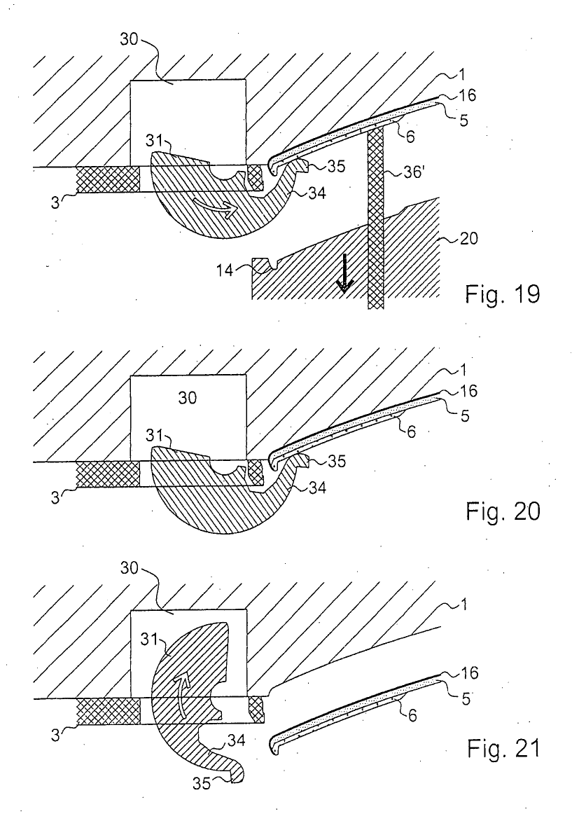

In a following step, the molding-on mold plate 20 is detached from the mold plate 1. The finished insert-molded two-component molded plastic part 5, 6, 16 is at the same time secured against falling off by the holding pin 36′. The holding mechanism 30 is actuated and takes over the holding function in the way already described. The holding pin 36′ is retracted according to the arrow in FIG. 19, so that the molding-on mold plate 20 can be completely removed (FIG. 20). Subsequently, in FIG. 21, the removal of the completed two-component molded plastic part 5, 6, 16 is performed, once it has been released by pivoting back the holding mechanism 30.

The production sequence described can be realized for example by what is known as a turning-plate injection mold. A turning-plate injection mold has a central plate, which is formed on both sides as a female mold plate according to the mold plate 1. Arranged to one side of the central plate is a counter mold plate 2 and to the other side a female mold plate 20. First, the first component is produced in the way described, in interaction with the counter mold plate 2. After that, the central plate is turned by 180°, the first component 5 remaining in the female depression of the central plate, as described above. The turning by 180° brings the plate side of the central plate with the initial product (first component) into position opposite the molding-on mold plate 20. With the next molding cycle of the injection-molding machine, a first component 5 is produced between the counter mold plate 2 and the plate side of the central plate that is facing the latter (corresponding to mold plate 1) and the second component 6 is molded onto the first component 5 between the opposite plate side of the central plate (corresponding to mold plate 1) and the molding-on mold plate 20. In this way, a finished two-component molded plastic part 5, 6, 16 can be produced in every molding cycle.

It is pointed out that, in the case of an injection-molded plastic part as the first component 5, 16, the sealing element 11 may, according to the present invention, be configured both as a straightforward film projection (as shown for example in FIGS. 6 to 21) or as a sealing continuation molded integrally onto the first component 5, with or without an end of the film protruding into the sealing continuation 11. Furthermore, in a way not represented, the first component 5 may also be realized exclusively as a film, which is preformed by thermal forming and laid into the depression of the mold plate 1. In this case, the counter mold plate 2 is not required.

Accordingly, different dimensionings are obtained for the recess 10 on the vertical flash face slide 3, 4.

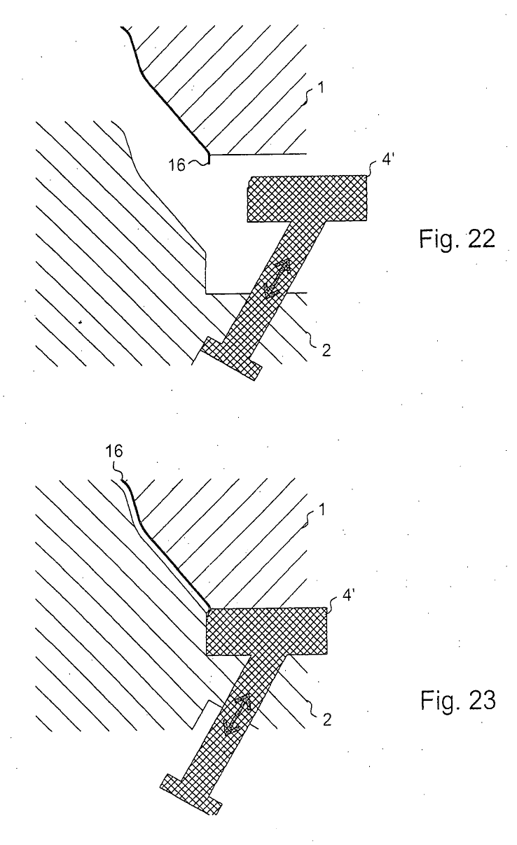

Furthermore, in a way not represented, the vertical flash face slide may also be an oblique slide, which is for example mounted in a positionally displaceable manner on the counter mold plate 2. FIGS. 22 and 23 show such a variant in which the vertical flash face slide is configured as an oblique slide 4′ on the mold core side. The oblique slide 4′ has a slide head and a slide rod, which is connected to the slide head and oriented obliquely in relation to the closing direction of mold plates 1, 2. When mold plates 1, 2 are open, the oblique slide 4′ is extended and exposes the vertical flash face, see FIG. 22. When the mold plates 1, 2 close, the vertical flash face slide 4′ is pressed downward into its end position by the mold plate 1. On account of the oblique position of the slide rod, the slide head thereby approaches the film 16, until the latter lies against the slide head, as shown in the previous figures. As a result, unproblematical insertion of the film projection into the recess between the slide head and the sealing face 8 of the counter mold plate is achieved.

Instead of the oblique slide 4′, a mold stroke insert arranged on the mold core side may also be used for creating the vertical flash face clearance, said insert differing from the oblique slide 4′ only in that its slide rod is oriented parallel to the direction of movement of the plates.

Furthermore, it is pointed out that the holding mechanism 30 according to the invention can be used in the case of any desired mold, that is to say for example also in the case of molds that are not intended for the production of multi-component molded plastic parts. To this extent, the disclosure of the application also covers an apparatus for producing a plastic part, comprising a mold plate 1 and a counter mold plate 2, a cavity for the injection-molding of the plastic part 5 being formed in the closed state of the mold plates 1, 2 between the latter, and comprising a holding mechanism 30, 31, 34, 35, which is designed to engage laterally from outside the contour of the cavity into the region of the cavity when mold plates 1, 2 are open and to fix an initial product 16; 5 of the plastic part or the finished plastic part 5, 6, 16 on one of the mold plates 1, 2. Furthermore, the disclosure covers a method, explained by way of example on the basis of FIGS. 6 to 21, of handling an initial product 16; 5 of the plastic part or the finished plastic part 5, 6, 16.

1. A molded plastic part, comprising:
a plastic part and
a plastic component molded onto the plastic part, the plastic part having a portion at the border which is insert-molded by the polymer melt of the molded-on plastic component.

2. The molded plastic part according to claim 1, the portion extending at the lateral border of the molded-on plastic component.

3. The molded plastic part according to claim 1, the portion being bent back over the plastic part.

4. The molded plastic part according to claim 1, the plastic part containing a film.

5. The molded plastic part according to claim 4, the portion being an end portion of the film protruding from the plastic part.

6. The molded plastic part according to claim 4, the portion being formed from the plastic of the plastic part and an end portion of the film protruding into the portion.

7. The molded plastic part according to claim 4, the plastic part being exclusively a film.

8. The molded plastic part according to claim 1, the plastic part being an injection-molded plastic part without a laid-in film.

9. The molded plastic part according to claim 1, a further portion extending away from the plastic part, the polymer melt of the molded-on plastic component being located between the portions.

10. The molded plastic part according to claim 1, the plastic part being transparent.

11. The molded plastic part according to claim 1, the molded-on plastic component running around the plastic part in the manner of a frame.

12. A method of molding a plastic component onto a plastic part, comprising:
providing the plastic part alongside a first mold plate, a sealing element that projects at the border beyond a surface of the first mold plate being formed on the plastic part;
bringing a second mold plate up close to the first mold plate, a sealing face being provided on the second mold plate in the region of the sealing element;
injecting plastic-into a cavity between the plastic part and the second mold plate that is sealed at the border by contact between the sealing element and the sealing face, to mold the plastic component onto the plastic part.

13. The method according to claim 12, the sealing element being flexurally elastic.

14. The method according to claim 12, the sealing element lying in contact with the sealing face under flexural prestress at the beginning of the injection of polymer melt into the cavity.

15. The method according to claim 13, the sealing element not lying in contact with the sealing face at the beginning of the injection of polymer melt into the cavity and being bent against the sealing face by the plastic being injected.

16. The method according to claim 12, the mold plates being spaced apart at the beginning of the injection of polymer melt into the cavity.

17. The method according to claim 12, the mold plates being moved apart during the injection of polymer melt into the cavity.

18. The method according to claim 17, the sealing element remaining in sealing contact with the sealing face on the second mold plate when the mold plates are moved apart.

19. The method according to claim 12, comprising the further step of:
moving the mold plates together, the sealing element arranged on the plastic part remaining in sealing contact with the sealing face on the second mold plate during the moving together of the mold plates.

20. The method according to claim 12, the plastic part being an injection-molded plastic part containing a film.

21. The method according to claim 20, the sealing element being realized as an end portion of the film protruding from the plastic part.

22. The method according to claim 20, the sealing element being formed from the plastic of the plastic part and an end portion of the film protruding into the sealing element.

23. The method according to claim 12, the plastic part being an injection-molded plastic part without a laid-in film.

24. The method according to claim 12, the plastic part being exclusively a film.

25. The method according to claim 12, the sealing element being heated before or during contact with the sealing face.
